(19) United States
(12) Patent Application Publication
(10) Pub. No.: US 2006/0210050 A1
(43) Pub. Date: Sep. 21, 2006

(54) Method and system for grouping in-premises devices and setting operational rules thereof

(76) Inventors: Eyal Bartfeld, Lexington, MA (US); Giora Keinan, Rishon LeZion (IL); Nimrod Gal-Oz, Lehavim (IL)

Correspondence Address: SALTAMAR INNOVATIONS, 30 FERN LANE, SOUTH PORTLAND, ME, 04106, US

(21) Appl. No.: 11/082,339

(22) Filed: Mar. 17, 2005

(51) Int. Cl. H04M 3/00

(52) U.S. Cl. 379/265.01

(57) ABSTRACT

In its broadest form, the present invention provides a method for user assisted association between devices in two classes of service, such as a telephony device and a notification device. By way of example, a user logs on to a server. At least one telephone number is associated with the user. An agent on a notification device such as a television, PDA, PC, etc. is activated, and displays a code received directly or indirectly from the server. When the authenticated user enters the code, the server is able to associate the telephone number and the notification device. Call information or call management capacity may therefore be provided via the notification device. Optionally, the user may also specify rules for handling calls and/or call information. The invention similarly extends to self provisioning between other service types and networks.

### FIELD OF THE INVENTION

This invention relates generally to television/telephony and computing devices, and more particularly to a method for automatic matching between telephony equipment television equipment and other digital devices such as set-top boxes, cable modems, personal computers, and the like.

### BACKGROUND OF THE INVENTION

Digital distribution networks are offering more and more services such as video (television), data, messaging and telephony. Personal computers, Personal Digital Assistants (PDA hereinafter), and certain entertainment devices such as electronic games and music players, are being interconnected at a rising pace, and are also connected to communication networks. It is desirable to provide integration between the services offered for those devices. Examples of services that are enabled by having such integration are caller identification (Caller ID, or CID) on screen, utilizing a television, personal computer, PDA's, mobile telephones, and the like. Another service is call management of telephone calls, voicemail, and other telephony features using similar screen devices. These services benefit from the display offered by a television or computer screen or the likes. Delivery of multiple services on a single network is commonly accomplished by utilizing different interface equipment between the distribution network and the different types of service. For example, in a television distribution network television services require a converter or receiver commonly referred to as a Set-Top Box (STB). Telephony service in such network are most often accomplished by a Media Terminal Adapter (MTA) which is sometimes embedded within a cable modem. Similarly, a telephony network that supplies television services accomplishes this task by utilizing telephones and separate interface devices for video and/or data. Some distribution networks may provide a variety of services over a converged, often IP-based, network where separation of signals for various services occurs at a home gateway device.

Yet another example of the convergence between different services is the case of separate networks that are cross linked. Thus for example a cellular network provider may link services with a television provider for example in order to display voice message arrival or in some cases caller ID services using a television screen. Another example is the integration of in-premises network such as the extension of a data network by a home or office network

The convergence between services further allows for integration of different types of services. Thus for example it is may be desirable to combine the telephony control services such as call forwarding, call rejection, caller ID and the like, for handling not only by a telephone but also by other devices. Thus for example it is advantageous to display caller ID information, or presence of a voicemail message on a television or a computer screen. Similarly, call control services such as phone redirection and the like will also benefit from the large screen format and possibly a keyboard or remote control devices provided by a television, PDA, or a PC (Personal Computer). In these specifications devices that are used for notification and/or management of services and events occurring in a device primarily used for a different service are referred to as notification devices. Thus for example, a television or a PC that are used for event notification and management of telephony services for example, are referred to as notification devices.

For clarity, the present invention will be described in terms of a television distribution network, but those skilled in the art will recognize the applicability of the present invention to telephony networks, as both are used as a television distribution networks with the main distinction being their ‘traditional’ role prior to integrating other services. Therefore the invention should be construed as extending to any distribution network that is adapted to carry television and telephony signals, as well as to a plurality of networks, where associations of television, computers, PDAs, and different communication devices and/or interfaces where cross functionality between the networks devices coupled thereto is desired. The telephony network, the data network, and the television network may be the same network, or different networks each combining one or more of the services. Those networks extend to the like of cable, wireless, telephony network, cellular network, local area networks, and the like.

As this application will utilize a cable television network example for clarity, the term set-top box (STB for short) will be used hereinafter to denote any addressable interface between a television or video capable network and a television or a video display device. The term MTA will be used hereinafter to denote any addressable interface between a network that is adapted to carry telephony signals and a telephony device. An MTA may be embedded in other devices such as a cable modem, and in some cases even within the telephony device, for example within an IP enabled telephone, cellular telephones, or PBX (Private Branch eXchange). Telephony devices may be individual telephones, cellular telephones, cable modems, satellite phones, IP based telephones, PBX systems, and the like.

Each notification device is individually addressable. Each user may have one or more notification devices that need to be associated with a corresponding service, such as a telephone.

U.S. patent application Ser. No. 10/904,552, filed Nov. 16, 2004 by the present inventors, which were under obligation to assign to a common assignee at the time this invention was made, titled “Method for association between telephony and television network equipment”, discloses a method for association between telephony equipment and television equipment by sending a code request from an addressable set-top box, identifying the set-top box address. A server generates a code and associates the code with the set-top address, and transmits the code back to the set-top box. The set-top box displays the code, preferably on a television screen. Using a telephony device, the code is transmitted by a user, to the server. The server identifies the telephony device address (either automatically or manually), and using the code, associates the telephony device with the set-top box. The above identified U.S. patent application (Ser. No. 10/904,552) is hereby incorporated by reference in its entirety for any and all purposes.

Network operators oftentimes meet difficulties in associating the different notification devices associated with individual users. Such association is done either manually or by programming that oftentimes needs to interface two or more separate software systems, at significant programming effort. If one of the systems changes, the programming needs to change as well, with additional expenses and with the risk of interrupted service. Even for networks utilizing central home gateway devices, it is desired to identify the addresses of various notification devices and to be able to associate between different devices, as these devices may be replaced due to failure or may be purchased individually by the end user. Therefore there is a need for a solution for allowing the end user to associate the different notification devices and services.

Furthermore, it is also desirable to allow the end user to determine certain rules for handling messages and controlling services related to those devices. Thus for example it is desirable to allow the user to reject certain calls based on the caller, direct certain caller ID information to a specific STB and other caller ID information to another, control common services, and the like. The present invention is directed to overcoming those difficulties, and providing such services.

### SUMMARY OF THE INVENTION

In its broadest form, the present invention therefore provides a method for user assisted association between a telephony device and a notification device, the method comprising the steps of:
from a web enabled device, accepting information regarding a user identity;
retrieving at least one telephone number associated with the user;
activating an agent operable on a notification device having an address, to display a code on the notification device;
receiving said code from the user via the web enabled device; and,
associating the notification device address with the telephone number.

Preferably the method further comprises step such as authenticating the user identity, comprising the step of receiving rules for activating the notification device. Also preferably the method further comprises the steps of receiving a code request from a notification device, selecting the code to be sent to the notification device, and associating the code with an address of the notification device.

When the method is directed to a plurality of telephone numbers, preferably also the step of receiving from a user rules for redirecting a telephone call to one telephone number to another telephone number. More preferably the user may name the notification device, and or the telephone line.

The rules may dictate diverting a telephone call directed to the telephone number, be time related, relate to the originating telephone number (e.g. rejection of calls from a certain telephone number, giving priority to a certain telephone number, and the like). The notification device in the preferred embodiment is a television, but may be other devices such as a PDA, a PC, a dedicated display device, and the like.

The notification may comprise information such as caller ID information, voice mail information (with possible voice mail delivery), and generally other information relating to events in the originating service.

In another aspect of the present invention there is provided a method for call management comprising the steps of:
authenticating a user communicating via a web enabled device;
associating at least one telephone number with the user;
accepting from the user rules regarding handling telephone calls received for the at least one telephone number.

The rules may dictate whether to cause the telephone associated with the at least one telephone number to ring, and/or may comprise handling instructions according to the identity of the caller, and/or be activated in accordance with the time a call arrives for the at least one telephone number, and/or instructs a telephony switch to redirect the incoming call. The rules may also cause a notification to be sent to a notification device when a call arrives. Preferably, the rules instruct a telephony/television gateway to display information about a call on a television device. Such notification may relate rules relate to sending a notification to the presence of a waiting voice mail message.

In yet another embodiment of the present invention, there is provided a system for user assisted association between a notification device and a telephone number, the system comprising a web enabled server constructed to receive information regarding a user identity from a web enabled device, retrieve at least one telephone number associated with the user, cause a message to be send to a notification device, the message comprising a code, receive the code from the user, and associate the at least one telephone number with the notification device.

### SHORT DESCRIPTION OF DRAWINGS

The invention will be better understood with the aid of the accompanying drawings in which:

FIG. 1 depicts a typical system appropriate for operation of the invention.

FIG. 2 depicts a simplified flow diagram for an aspect of the present invention.

FIG. 3 depicts a simplified flow diagram of the steps of retrieving the telephone number associated with the user.

FIG. 4 depicts another simplified flow diagram of the steps of retrieving the telephone number associated with the user.

FIG. 5 depicts an example screen of provisioning response to receiving a call on a number of telephone lines.

depicts an example screen showing yet another example of rules that may be dictated by the user.

### DETAILED DESCRIPTION

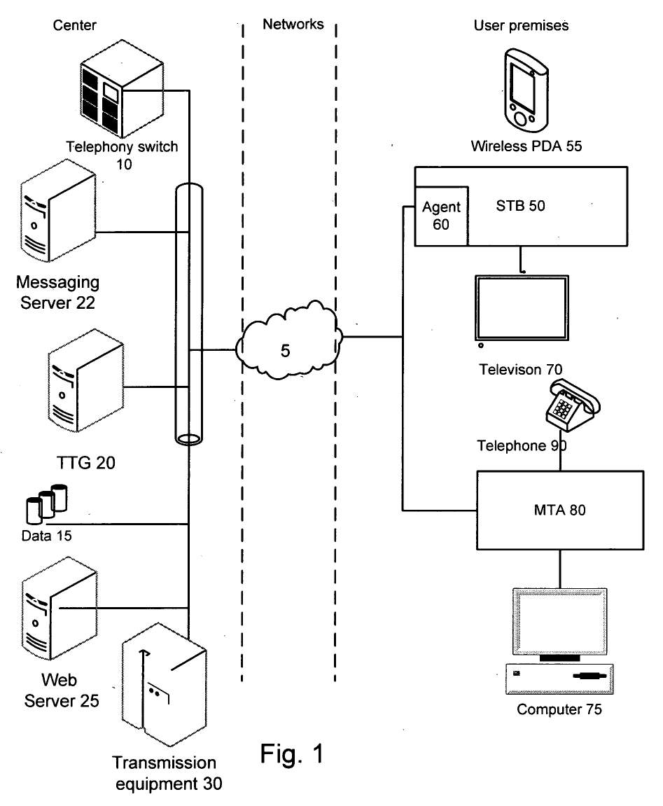

FIG. 1 depicts a typical environment in which the invention operates. A central location (e.g. a head-end) contains transmission equipment 30, which is capable of transmitting television signals, and optionally data and telephony signals. A VoIP-switch (Voice over Internet Protocol) or a telephony switch 10 is coupled to an external telephony network, and is capable of receiving and routing telephone calls from either in-network or the external network. A Television/Telephony Gateway (TTG) 20 which is capable of storing and transmitting information to a television or other notification device, telephony related information such as voicemail Message Waiting Indication and handling caller ID information. A messaging server 22 may also be coupled to the system, and provide functionality such as voice mail, unified messaging services, and the like. A web server 25 capable of handling hypertext, XML, SSL or similar web like protocols, and a database 15 that is accessible from the TTG, the web server, or any combination thereof. The database is configured to contain at least pairs of Telephone addresses and notification device addresses. The center is coupled to the network 5, directly or indirectly. A plurality of networks of different types may be utilized.

It is noted that this typical configuration is provided by way of example and the skilled in the art will recognize that modifications to this arrangement are known in the art, and such modification may include having the database divided between several computers, or having several databases, with partial data of the pairing between user, telephone, and notification devices that may or may not be duplicated between the databases. Other modifications include integration between certain components of the center, and various methods of communicating therebetween. It is further recognized that the different components may be operated by different entities, and possibly in different geographical locations. Certain components may not be programmed to cooperate with other components, except as required for the operation of the invention.

The implementation of the servers 20, 22, and 25, as well as the telephony switch 10, is a matter of technical choice, and it should be understood that while a single server may be utilized, the more common case will include a distributed server, whereas certain functionality such as the database handling may reside on one physical computer and other functionality such as communicating with devices, may reside on other computers. A single server may incorporate computers and other devices such as a telephony switch, television transmission equipment, cellular network control nodes, TTG, messaging server, and the like. The center may also be distributed geographically and operable by a plurality of entities.

The user premises contain at least one notification device such as STB 50 coupled to a television, a PDA 55 capable of communicating with a local area network or a wireless network, and a PC 75. In a typical environment the PC and likely a telephone 90, will be coupled to an MTA 80.

An agent software 60, shown only on STB 50, is provided for each notification device to which cross service notification is desired. Agents are software or hardware that resides in the device or in a device coupled to the notification device.

The agent software 60 may be activated automatically and/or by the user, such as by selecting the function from a menu. If desired, the agent software may also be downloaded on demand after a user action. The agent software may be activated automatically on power-up of a notification device. Alternatively, a network operator may download an agent to the STB to advertise offered cross notification services.

FIG. 1 also shows a PC 75 coupled to MTA 80, however any computer coupled to the Internet, or otherwise capable of communicating directly or indirectly with web server 25, would be operable for the needs of the invention. Similarly, a PDA, or other web enabled device such as web enabled television or similar device would be similarly operable for the needs of the invention. For clarity, the following explanation will use the PC 75 as the web enabled device, the television 70 and coupled STB 50 as the notification device, and the telephone 90 as an example of a telephony device.

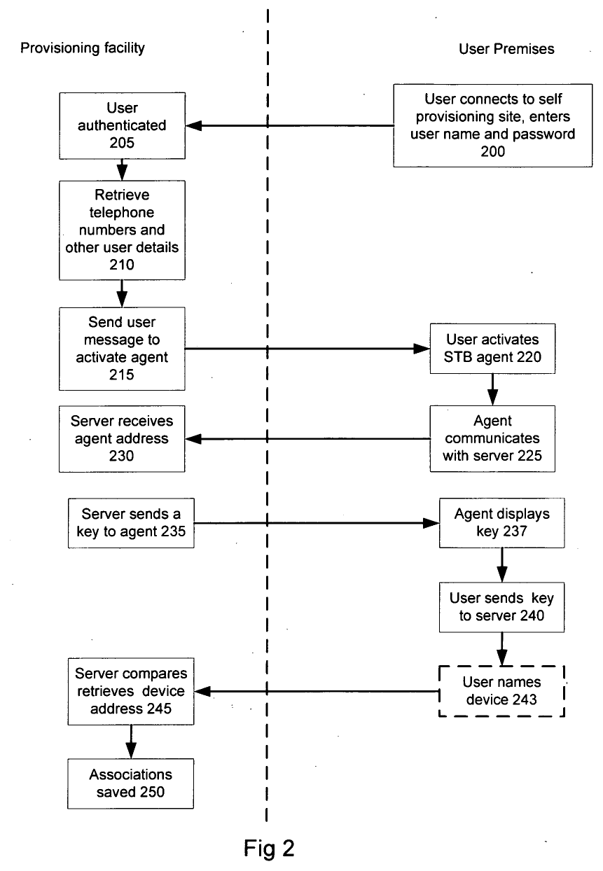

FIG. 2 is a simplified flow diagram of the operation of an initial agent registration according to the preferred embodiment of the invention. By registering an agent it is assumed that the device coupled to the agent is also registered. Thus, registering the agent 60 embodied as software operable by STB 50 will be related to as registering the television device coupled to the STB. Similarly, registering an agent embodied as software operable on a personal computer will be considered as registering the personal computer.

In order to register a device, the user utilizes his PC to log in 200 to a provisioning web site residing on web server 25. The web server authenticates the user identity such as by user name and password, as known. The authentication step provides desired security to prevent unauthorized tampering with the user services, and for protecting the user privacy as regards to certain services.

After authentication, the web server 25 queries the database 15 (or another database) and retrieves 210 one or more telephone numbers associated with the user. If the user does not have an associated telephone, he is given an opportunity to enter one (not shown).

In order to authenticate a new device, the user activates an agent that resides on that device 220. The activation of the agent is specific to the notification device. In the current example the device is a television, and thus for example such activation may comprise tuning the STB 50 to a specific channel, or activating a special button on the STB or a remote control. In response, the STB than activates the agent 60. If for example the notification device is a PC or a PDA the user may be asked to activate certain software. It will be clear that many other manners of activating an agent are available, and the specific manner is a matter of technical choice that will be clear to the skilled in the art. Preferably, the server instructs the user to activate the agent 215.

When the agent 60 is activated, it communicates with the server 225 providing information regarding the notification device address. Preferably, other information is provided regarding the nature of the device, and/or communication link characteristics, and/or certain capabilities of the device and/or agent.

Upon receiving of the agent address 230, the server generates a key and associates that key with the notification device address. The key is preferably a series of digits and characters. The server than communicates the key to the agent 235. Alternatively, the key is further communicated to the user web client.

The agent causes the key to be displayed 237 on the notification device. In the example this implies displaying the key on the television screen, preferably with instructions to the user to copy the key, and then enter the key to his web browser page. The user utilizes the PC to send the key to the server 240. Upon reception of the key, the server associates the notification device address with a user 250 and thereof with the other devices that user may have. Thus an association is created between the user telephone numbers and the notification device. The link is stored, and may now be utilized by the TTG 20 to send information to one service when an event occurs in another service.

In the preferred embodiment, the user is further requested to name or otherwise identify the notification device. This is advantageous as the user may have a plurality of notification devices, and each may respond differently.

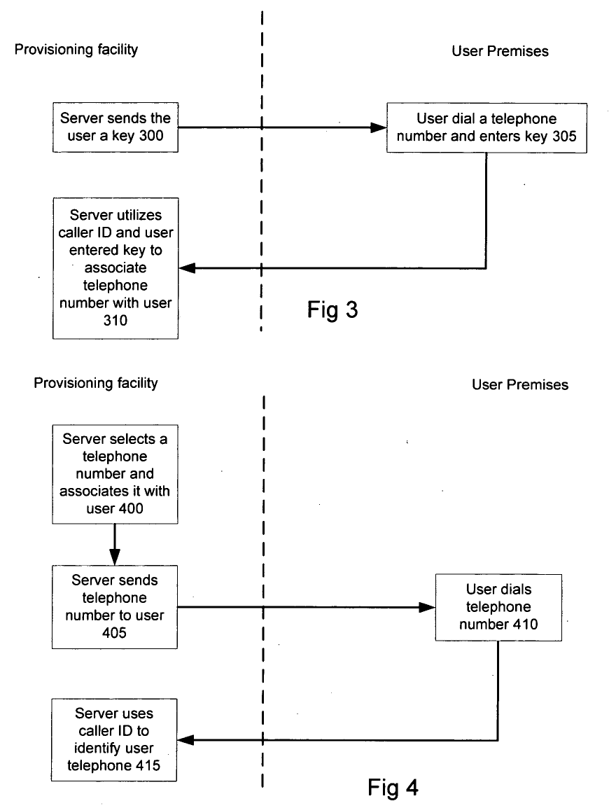

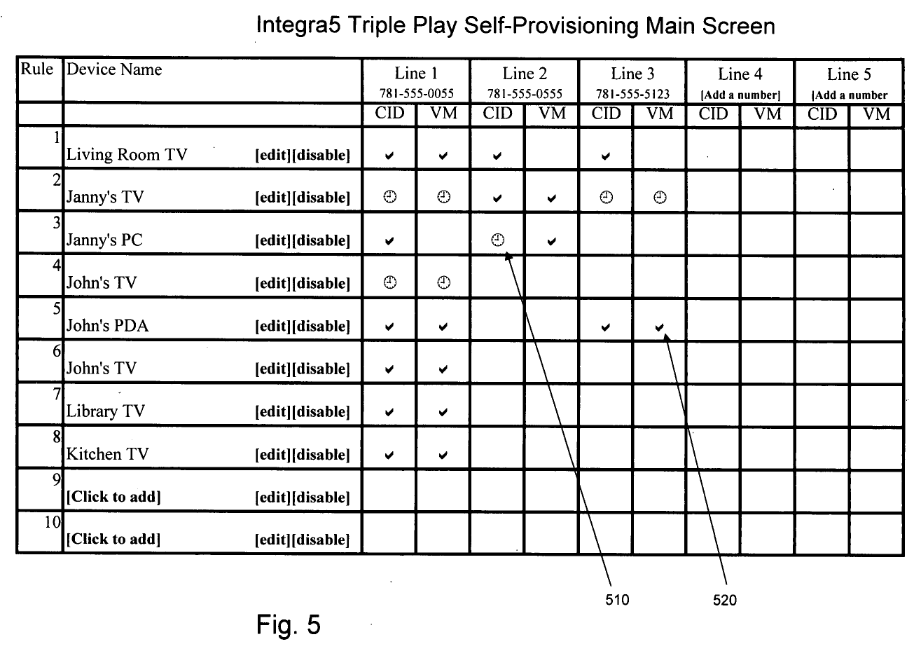

In certain cases the server does not have expedient access to information relating telephone numbers and the user, as described in step 210. Thus the step of retrieving the telephone number associated with the user 210, may optionally be preformed as shown in FIG. 3 or FIG. 4. In FIG. 3, the server sends a key, and preferably a telephone number to the user PC 300. The user then dials the telephone number 305 and enters the key. The server utilizes the key and the caller ID of the calling telephone to identify the user telephone number 310. Equivalently, if caller ID service is unavailable, the user may enter it manually. FIG. 4 depicts a similar arrangement, however this method requires a block of telephone numbers that the server can monitor. The server selects a telephone number from the block of telephone numbers 400, and communicates it to the user 405. The user then dials the telephone number 410, and the computer again uses the caller ID, or manually entered information, to associate the telephone number with the user.

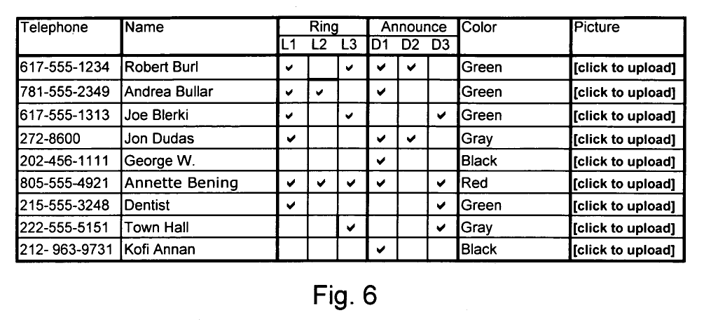

Once the association is created, the preferred embodiment can address another objective, which is allowing the user to direct the manner in which events in one type of service reflect on other types of services. Thus for example, as can be seen in the simplified screen examples of FIGS. 5 and 6. FIG. 5 depicts a table connecting between notification devices and actions taken in those notification devices. Therefore for each line representing a notification device, the user is allowed to create a set of responses corresponding with events occurring in a different media. FIG. 5 provides an example of provisioning response to receiving a call on a number of telephone lines, indicated by the columns marked “Line 1”, “Line 2”, etc. Lines 4 and 5 may be added. Different notification devices enumerated in the column marked “Device Name”. The figure allows the user to edit or disable activity on the notification devices as desired. A checkmark 520 in a CID column means that caller ID and potentially additional call information will be sent to the corresponding notification device when a call is attempted via the respective line. A clock icon indicates that the information will be sent only if the call attempt occurs within a specified time range. Similarly, the checkmark and the clock icon operate to inform the notification device of existence of pending voice mail messages.

FIG. 6 depicts an example screen showing yet another example of rules that may be dictated by the user. In this example, certain telephone numbers, and possibly names, are identified with certain activities. The user is able to dictate that when a certain party calls, which notification events take place. Thus for example a call to one telephone line may cause more than one line to ring, and announce on a plurality of notification device (denoted by D1, D2, and D3). Similarly, specific callers may be completely blocked simply be not allowing any phone lines to ring in response to a call attempt by specific user. Moreover, the user is able to select a color for the notification and optionally specify a picture identifying the calling party. Such picture will be displayed on the notification device as a part of the caller ID annunciation.

Data derived from screens such as depicted in FIGS. 5 and 6 is used to create rule sets that are stored in database 15. The rule sets allow the telephony switch and/or the messaging server 20 to query the database upon a call attempt. In the preferred embodiment, when a call attempt arrives at the telephony switch 10 the switch checks for existence of rules specific for the call at hand. This is preferably done by utilizing telephony protocols such as SS7/AIN or SIP, or by direct communications between the telephony switch and the TTG. The switch consults with TTG 20 as for handling method for the call. The TTG searches the data base for rules defined by the user. If a rule or rules exist, the TTG may instruct the telephony switch to cause the target telephone to ring, may divert the call to another telephone or to voice mail, block the call, play announcement, and the like. Such notification may be implemented via any convenient means such as a network, but in some embodiments, the messaging server itself may be coupled to a telephony control and signaling network such as an SS7 compliant communication link, in which case no notification is required, as the data is directly available to the messaging server. Utilizing database 15 the messaging server checks if any rules in the database match the conditions of the call at hand. If a match is found, the rules are acted upon. The messaging server sends information to notification devices according to the matching rules, or if no rules are found, according to a default rule set.

We claim:

1. A method for user assisted association between a telephony device and a notification device, the method comprising the steps of:
from a web enabled device, accepting information regarding a user identity;
retrieving at least one telephone number associated with the user;
activating an agent operable on a notification device having an address, to display a code on the notification device;
receiving said code from the user via the web enabled device; and,
associating the notification device address with the telephone number.

2. A method for user assisted association between a telephony device and a notification device as claimed in claim 1, further comprising the step of authenticating the user identity.

3. A method for user assisted association between a telephony device and a notification device as claimed in claim 1, further comprising the step of receiving rules for activating the notification device.

4. A method for user assisted association between a telephony device and a notification device as claimed in claim 1, wherein the method is directed to a plurality of telephone numbers, and further comprising the step of receiving from a user rules for redirecting a telephone call to one telephone number to another telephone number.

5. A method for user assisted association between a telephony device and a notification device as claimed in claim 1, further comprising the step of naming a notification device.

6. A method for user assisted association between a telephony device and a notification device as claimed in claim 1, further comprising the step of naming a telephone number.

7. A method for user assisted association between a telephony device and a notification device as claimed in claim 1,further comprising the step of receiving rules for diverting a telephone call directed to the telephone number.

8. A method for user assisted association between a telephony device and a notification device as claimed in claim 6, wherein the rules are time related.

9. A method for user assisted association between a telephony device and a notification device as claimed in claim 1, wherein the rules relate to the originating telephone number.

10. A method for user assisted association between a telephony device and a notification device as claimed in claim 1, wherein the notification device is a television.

11. A method for user assisted association between a telephony device and a notification device as claimed in claim 10, wherein the notification comprise information about the identity of a calling party.

12. A method for user assisted association between a telephony device and a notification device as claimed in claim 1, wherein the notification device is selected from a list consisting a PDA, a computer, a dedicated display device, or a combination thereof.

13. A method for user assisted association between a telephony device and a notification device as claimed in claim 1, further comprising the step of, before the step of activating:
receiving a code request from a notification device;
selecting the code to be sent to the notification device; and,
associating the code with an address of the notification device.

14. A method for call management comprising the steps of:
authenticating a user communicating via a web enabled device;
associating at least one telephone number with the user;
accepting from the user rules regarding handling telephone calls received for the at least one telephone number.

15. A method for call management as claimed in claim 14, wherein the rules dictate whether to cause the telephone associated with the at least one telephone number to ring.

16. A method for call management as claimed in claim 14, wherein the rules comprise handling instructions according to the identity of the caller.

17. A method for call management as claimed in claim 14, wherein the rules are activated in accordance with the time a call arrives for the at least one telephone number.

18. A method for call management as claimed in claim 14, wherein the rules instructs a telephony switch to redirect the incoming call.

19. A method for call management as claimed in claim 14, wherein the rules cause a notification to be sent to a notification device when a call arrives.

20. A method for call management as claimed in claim 14, wherein the rules instruct a telephony/television gateway to display information about a call on a television device.

21. A method for call management as claimed in claim 14, wherein the rules relate to sending a notification to a notification device when a voice mail message is waiting for the at least one telephone number.

22. A system for user assisted association between a notification device and a telephone number, the method comprising:
A web enabled server constructed to:
receive information regarding a user identity from a web enabled device;
retrieve at least one telephone number associated with the user;
cause a message to be send to a notification device, the message comprising a code;
receive the code from the user; and,
associate the at least one telephone number with the notification device.
